(19) United States
(12) Patent Application Publication
(10) Pub. No.: US 2023/0266449 A1
(43) Pub. Date: Aug. 24, 2023

(54) TECHNIQUES FOR FAULT DETECTION IN A LIDAR SYSTEM

(71) Applicant: Aeva, Inc., Mountain View, CA (US)

(72) Inventors: Syrus Ziai, Los Altos, CA (US); Kumar Bhargav Viswanatha, Santa Clara, CA (US); Amol V. Gole, Sunnyvale, CA (US); Murat Ozbas, Penfield, NY (US); Mark Pude, Honeoye Falls, NY (US); Esha John, Sunnyvale, CA (US)

(21) Appl. No.: 18/162,529

(22) Filed: Jan. 31, 2023

Related U.S. Application Data
(60) Provisional application No. 63/312,794, filed on Feb. 22, 2022.

(51) Int. Cl. G01S 7/497; G01S 7/4911; G01S 17/58; G01S 7/481

(52) U.S. Cl. CPC G01S 7/497; G01S 7/4911; G01S 17/58; G01S 7/4817

(57) ABSTRACT

A method transmits a predetermined signal through a first channel that includes a first digital circuit to produce a first result. The first channel is a functional channel in the FMCW LIDAR system. The method retrieves a second result that is based on the predetermined signal, and determines whether the first result and the second result are nonequivalent. The method then invokes a fault signal in response to determining that the first result and the second result are nonequivalent.

### CROSS-REFERENCE TO RELATED APPLICATIONS

This application claims priority from and the benefit of U.S. Provisional Patent Application No. 63/312,794 filed Feb. 22, 2022, the entire contents of which are incorporated herein by reference.

### TECHNICAL FIELD

The present disclosure is related to light detection and ranging (LIDAR) systems, and more particularly to fault detection in a frequency-modulated continuous wave (FMCW) light detection and ranging (LIDAR) system.

### BACKGROUND

Frequency-modulated continuous wave (FMCW) LIDAR systems provide precise and reliable range, direction, and reflectance measurements that can be used for obstacle avoidance or measuring characteristics such as dimensions and reflectivity of objects in a scene within the sensor's field-of-view (FOV). During operation, faults may occur that could lead to safety failures or hazards.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One aspect disclosed herein is directed to a method of fault detection in an FMCW LIDAR system. As discussed herein, an FMCW LIDAR system may also be referred to as a LIDAR system.

According to some embodiments, the method transmits a predetermined signal through a first channel that includes a first digital circuit to produce a first result. The first channel is a functional channel in the FMCW LIDAR system. The method retrieves a second result that is based on the predetermined signal, and determines whether the first result and the second result are nonequivalent. The method then invokes a fault signal in response to determining that the first result and the second result are nonequivalent.

In some embodiments, the predetermined signal is an input data stream, and the first digital circuit processes the input data stream to produce a first output data stream. The method computes a first checksum from the first output data stream, which is the first result. The method transmits the predetermined signal through a second channel that includes a second digital circuit to produce a second output data stream. The method computes a second checksum from the second output data stream, which is the second result. The method invokes the fault signal responsive to determining that the first checksum is nonequivalent to the second checksum.

According to some embodiments, the FMCW LIDAR system includes an analog chip and a digital chip. The analog chip includes a first analog circuit and a second analog circuit, and the digital chip includes the first digital circuit and a second digital circuit. The method configures the first analog circuit and the second analog circuit to produce a first analog output and a second analog output, respectively. The method uses a first analog to digital converter (ADC) and a second ADC in the digital chip to convert the first analog output to a first digital signal and the second analog output to a second digital signal, respectively. The first digital circuit processes the first digital signal and produces the first result, and the second digital circuit processes the second digital signal and produces the second result.

According to some embodiments, the first digital circuit processes an input data stream and generates an output data stream. The method feeds the output data stream into checksum circuitry to produce the first result (e.g., checksum). The method then compares the checksum with the second result, which is a predetermined checksum value.

According to some embodiments, the first channel includes an analog chip coupled to a digital chip that includes the digital circuit. The method transmits the predetermined signal into analog circuitry, which produces an analog signal that feeds into the digital chip. The method uses an ADC to convert the analog signal to a digital signal. The first digital circuit processes the digital signal to produce the first result, and the second result is a predetermined value that is stored in the digital circuit.

According to some embodiments, the method sends optical source configuration parameters to an optical source controller. The optical source controller transmits an optical beam into an environment based on the optical source configuration parameters. The method processes, by the first channel path, a returned beam signal generated from the optical beam reflecting off objects in the environment, and compares return beam properties of the returned beam signal with the optical source configuration parameters. The method then invokes the fault signal in response to determining that the properties of the returned beam signal and the optical source configuration parameters are nonequivalent.

According to some embodiments, the method sends scanner configuration parameters to an optical scanner. The method receives scanner feedback information from the optical scanner and compares the scanner feedback information with the scanner configuration parameters. The method then invokes the fault signal in response to determining that scanner feedback information and the scanner configuration parameters are nonequivalent.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects, and advantages will become apparent from the following detailed description taken in conjunction with the accompanying figures which illustrate, by way of example, the principles of some described example implementations.

### BRIEF DESCRIPTION OF THE DRAWINGS

For a more complete understanding of the various examples, reference is now made to the following detailed description taken in connection with the accompanying drawings in which like identifiers correspond to like elements.

FIG. 1 illustrates an example LIDAR system according to embodiments of the present disclosure.

FIG. 2 is a time-frequency diagram illustrating how LIDAR waveforms are detected and processed according to some embodiments of the present disclosure.

FIG. 3 is a block diagram illustrating an example of testing analog circuitry and digital circuity by injecting a known analog signal into multiple analog circuits and comparing results generated by multiple digital circuits coupled to the multiple analog channels, according to some embodiments of the present disclosure.

FIG. 4 is a block diagram illustrating an example of testing digital circuity by injecting a known digital signal into multiple digital circuits and comparing results generated by the multiple digital circuits, according to some embodiments of the present disclosure.

FIG. 5 is a block diagram illustrating an example of testing digital circuity by injecting a known digital signal into a single digital circuit and comparing results generated by the digital channel with a known stored value, according to some embodiments of the present disclosure.

FIG. 6 is a block diagram illustrating an example of testing analog circuity and inter-chip connections by injecting a known analog signal into a single analog circuit and comparing results generated by the channel with a known stored value, according to some embodiments of the present disclosure.

FIG. 7 is a block diagram illustrating an example of detecting faults in an optical source controller of an FMCW LIDAR system, according to some embodiments of the present disclosure.

FIG. 8 is a block diagram illustrating an example of detecting faults in optical scanner optics of an FMCW LIDAR system, according to some embodiments of the present disclosure.

FIG. 9 is a flow diagram illustrating a method for detecting faults in an FMCW LIDAR system, according to some embodiments of the present disclosure.

### DETAILED DESCRIPTION

According to some embodiments, the described LIDAR system described herein may be implemented in any sensing market, such as, but not limited to, transportation, manufacturing, metrology, medical, virtual reality, augmented reality, and security systems. According to some embodiments, the described LIDAR system is implemented as part of a front-end frequency modulated continuous-wave (FMCW) device that assists with spatial awareness for automated driver assist systems, or self-driving vehicles.

As discussed above, faults may occur during FMCW LIDAR operation that could lead to safety failures or hazards. Types of faults in a LIDAR system can include transient faults and stuck-at faults. Transient faults occur intermittently for a relatively short period of time after which the fault disappears and effect a small number of points in a point cloud generated by the system. Accordingly, transient faults may not result in safety violations due to the limited affect they have on the system. Transient faults can include single point or multipoint faults. Single point faults may be temporary (e.g., bit flip in logic for one clock cycle) or permanent (e.g., bit flip in twiddle factor memory).

Stuck-at faults are more permanent faults that can result in safety violations. Stuck-at faults may result from a malfunction or damage in hardware of a circuit. For example, a stuck-at fault may result from issues in the digital signal processing logic, an analog-to-digital converter (ADC), a laser chip or control logic, scanning optics or scanning optics control logic, etc. Stuck-at faults can include single point faults (e.g., a stuck inverter or gate) or multi-point faults that may result in significant effects on output results of a point cloud.

Functional safety is a part of the overall safety of a system that depends on automatic protection operating correctly in response to inputs or failures in a predictable manner. When there is a functional safety failure (violation) in the field, the system cannot keep functioning with the error and is required to detect the condition and either fix the error or report the error. A conventional approach to meeting this requirement is to duplicate all of the functional safety circuitry and vote on a result (e.g., majority rule), but this approach requires added circuitry and therefore increases material costs (silicon). Another conventional approach is a bottom up approach that analyzes every circuit to determine a probability of failure and identify those circuits to duplicate, which requires substantial resource time and also adds additional circuitry.

Accordingly, the present disclosure addresses the above-noted and other deficiencies by providing a top-down approach that identifies certain characteristics of the system and evaluates functional paths after every scan. By evaluating the functional paths after every scan, the approach detects functional safety violations using minimal additional circuitry and minimal circuit analysis resources.

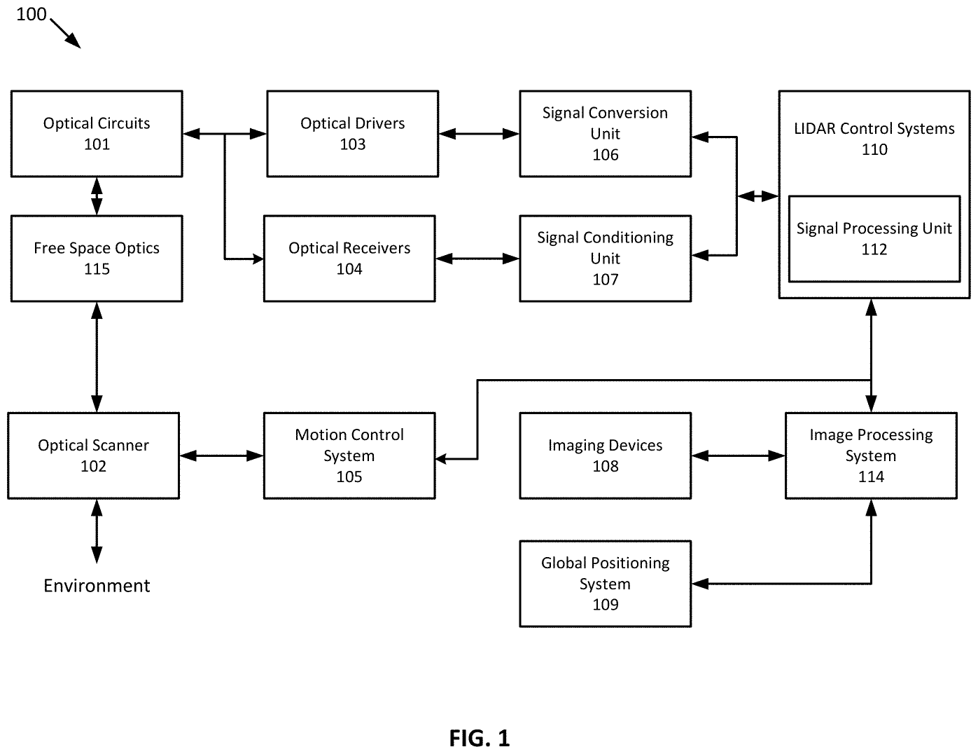

FIG. 1 illustrates a LIDAR system 100 according to example implementations of the present disclosure. The LIDAR system 100 includes one or more of each of a number of components, but may include fewer or additional components than shown in FIG. 1. As shown, the LIDAR system 100 includes optical circuits 101 implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a DSP. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using ADCs. The digital signals are then sent to the LIDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

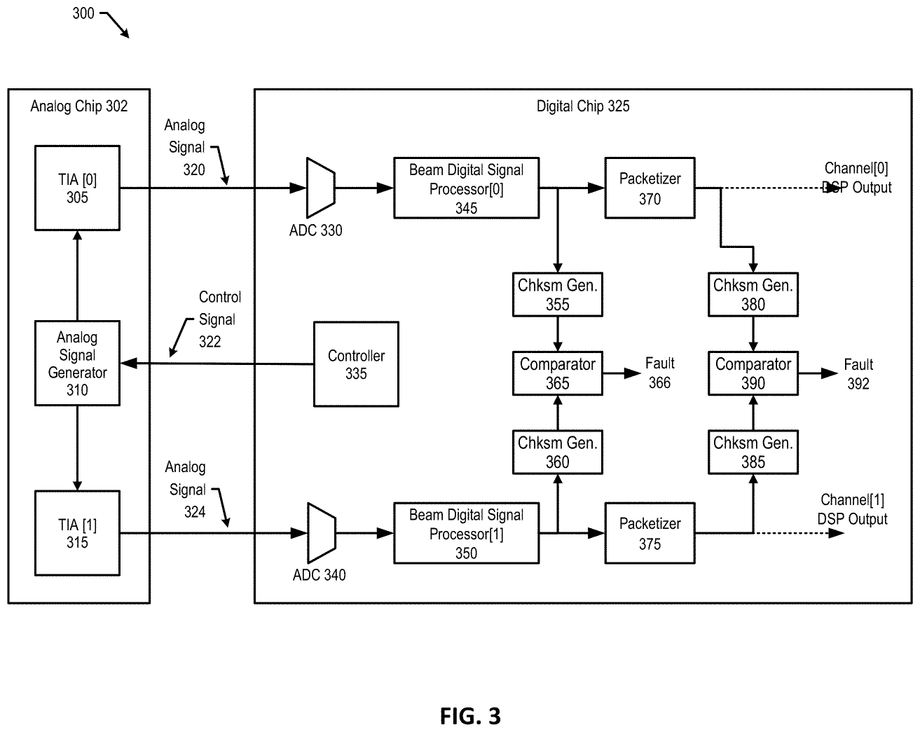

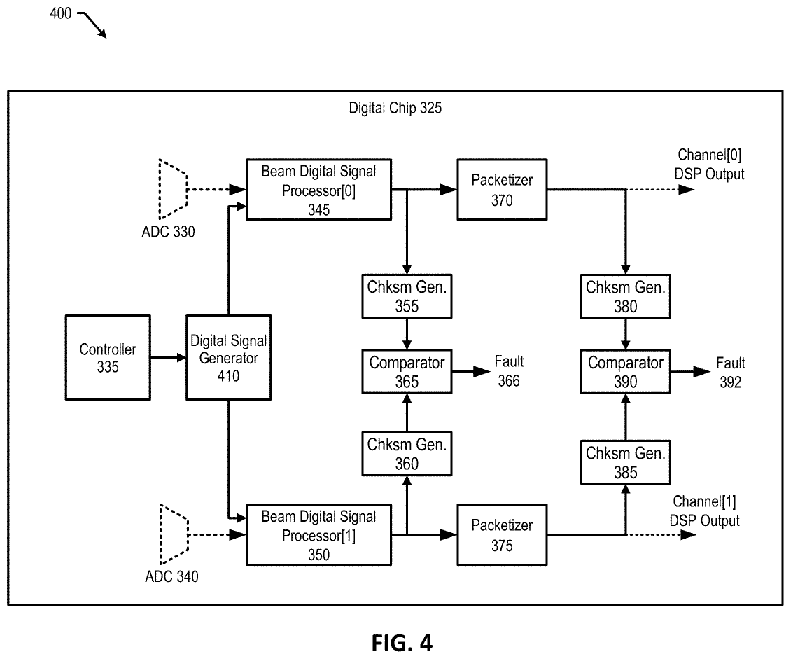

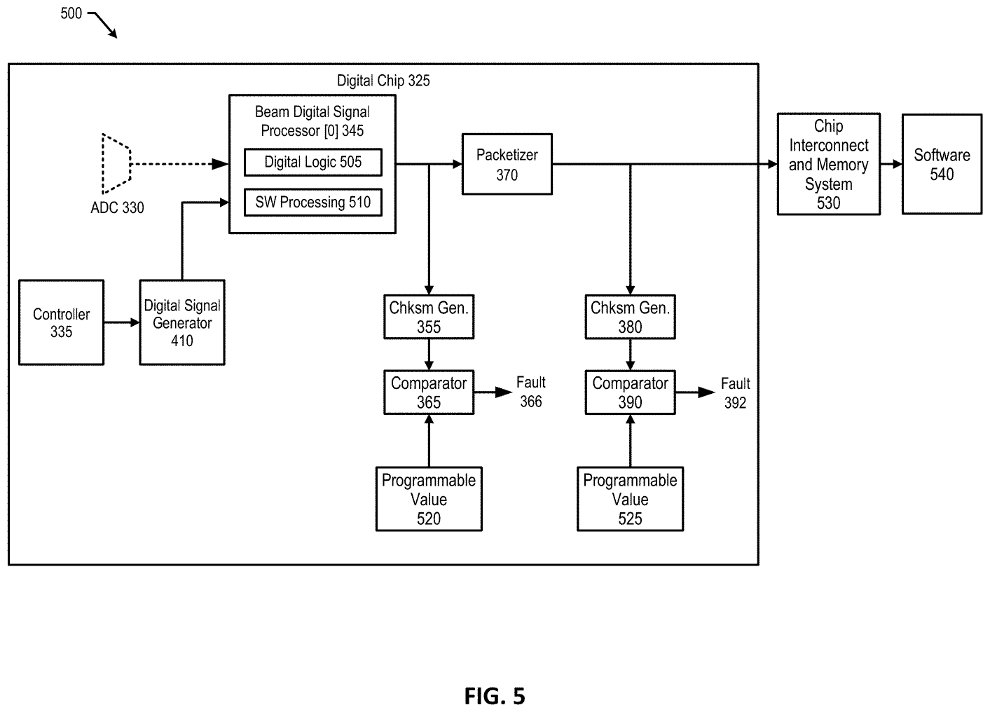

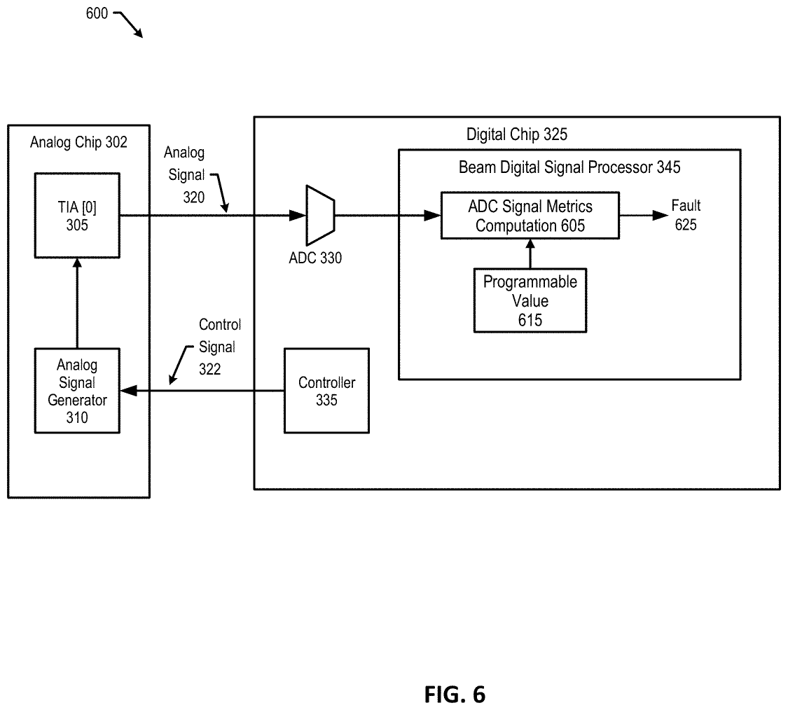

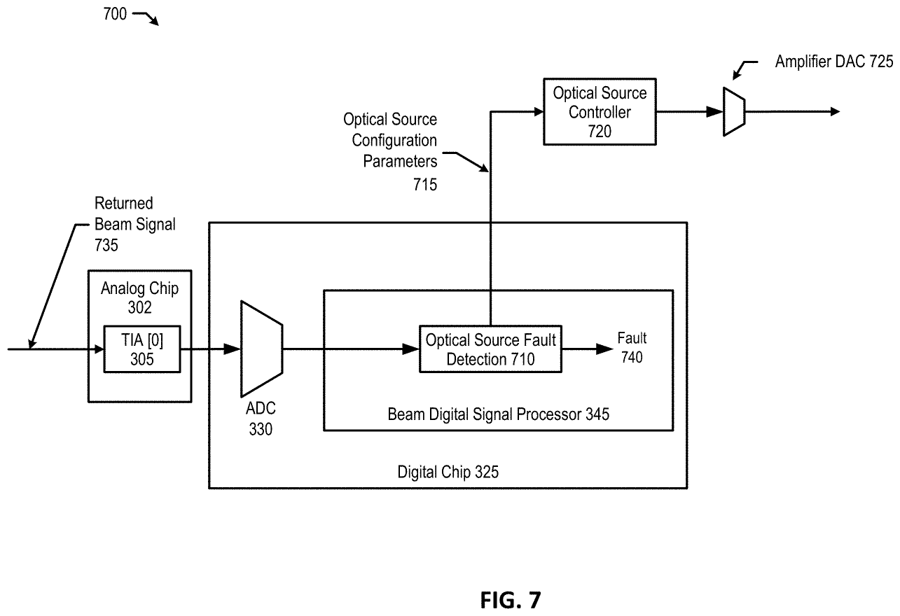

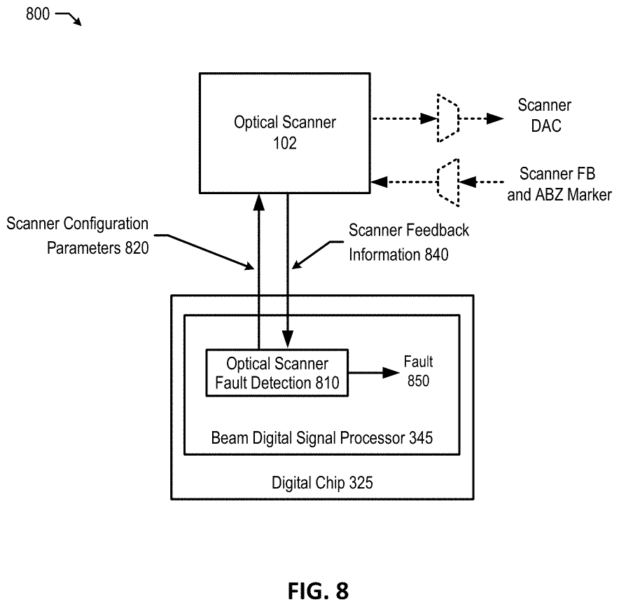

In some embodiments, signal conditioning unit 107 includes analog circuitry that couples to digital circuitry in LIDAR control systems 110 that are used as functional paths. As discussed below, the present disclosure provides several embodiments to test the functional path circuitry and report faults detected in the functional paths. FIGS. 3 and 4 shows embodiments of injecting know signals into multiple paths and comparing their results. FIGS. 5 and 6 show embodiments of injecting known signals (predetermined signals) into a single functional path and comparing the results with predetermined values. FIG. 7 shows an embodiment of testing the optical source controller (in optical drivers 103), and FIG. 8 shows an embodiment of testing optical scanner 102.

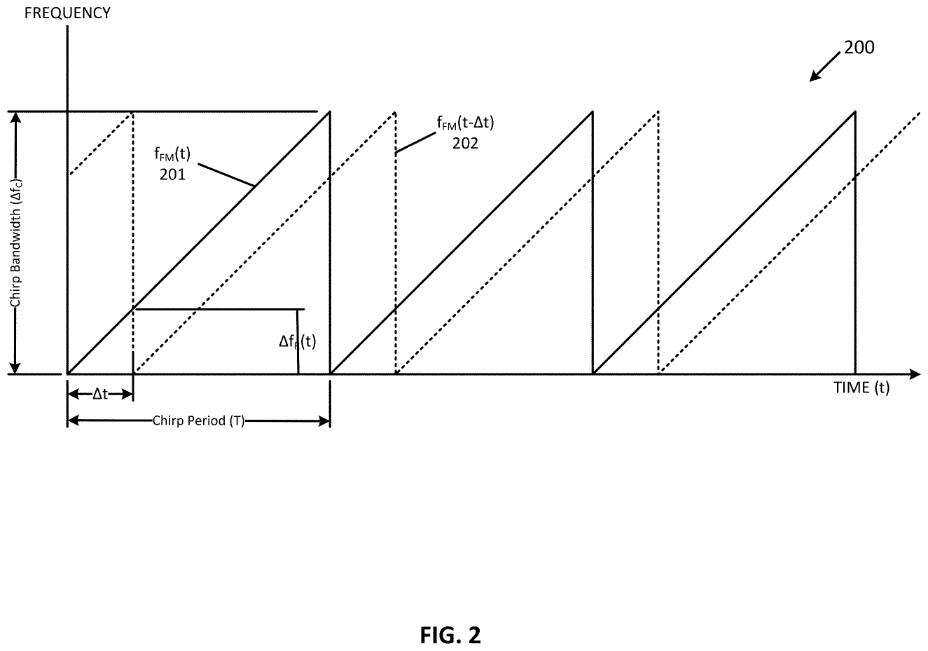

FIG. 2 is a time-frequency diagram illustrating how LIDAR waveforms are detected and processed according to some embodiments of the present disclosure. In one example, the scanning waveform 201, labeled as fFM(t), is a sawtooth waveform (sawtooth “chirp”) with a chirp bandwidth ΔfC and a chirp period TC. The slope of the sawtooth is given as k=(ΔfC/TC). FIG. 2 also depicts target return signal 202 according to some embodiments. Target return signal 202, labeled as fFM(t−Δt), is a time-delayed version of the scanning signal 201, where Δt is the round trip time to and from a target illuminated by scanning signal 201. The round trip time is given as Δt=2R/v, where R is the target range and v is the velocity of the optical beam, which is the speed of light c. The target range, R, can therefore be calculated as R=c(Δt/2). When the return signal 202 is optically mixed with the scanning signal, a range dependent difference frequency (“beat frequency”) ΔfR(t) is generated. The beat frequency ΔfR(t) is linearly related to the time delay Δt by the slope of the sawtooth k. That is, ΔfR(t)=kΔt. Since the target range R is proportional to Δt, the target range R can be calculated as R=(c/2)(ΔfR(t)/k). That is, the range R is linearly related to the beat frequency ΔfR(t). The beat frequency ΔfR(t) can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100. It should be noted that the target return signal 202 will, in general, also includes a frequency offset (Doppler shift) if the target has a velocity relative to the LIDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (e.g., the “Nyquist limit”). In one example, and without limitation, if the sampling frequency of the ADC is 1 gigahertz, then the highest beat frequency that can be processed without aliasing (ΔfRmax) is 500 megahertz. This limit in turn determines the maximum range of the system as Rmax=(c/2)(ΔfRmax/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

FIG. 3 is a block diagram illustrating an example of testing analog circuitry and digital circuity by injecting a known analog signal into multiple analog circuits and comparing results generated by multiple digital circuits coupled to the multiple analog channels, according to some embodiments of the present disclosure.

FMCW LIDAR 100 system may include an analog chip 302 for receiving and amplifying a signal received from one or more photodetectors. The FMCW LIDAR system 100 further includes a digital chip 325 for converting the analog signals to digital signals and processing the converted digital signals for target detection. During operation of the FMCW LIDAR system 100, faults may occur in the analog chip 302 or digital chip 325 that may cause unpredictable and/or incorrect outputs. Some faults may be transient or temporary and may be self-correcting. However, other faults may be longer lasting (e.g., stuck-at faults) resulting from hardware failures or the like.

During functional operation of the FMCW LIDAR system 100, an analog electrical signal is received at the analog chip 302 from one or more photodetectors that generate signals based on optical signal as described above with respect to FIG. 1 and FIG. 2. As depicted, the analog chip 302 and digital chip 325 include multiple channels. The analog chip 302 includes multiple trans-impedance amplifiers (TIAs) 305 and 315 that amplify the electrical signal. Analog signals 320 and 324 are then provided to digital chip 325 for processing by beam digital signal processors 345 and 350. The processed information then gets packetized via packetizer 370 and 375 and sent to a destination for further processing.

In some embodiments, for small windows of time, the FMCW LIDAR system 100 may not be actively receiving signals from the photodetectors and the TIAs. For example, a signal may be received during 80% of processing cycles and during the other 20% no signal is received. During the 20% down time, a known signal can be inserted into the TIAs and be processed through the entire channel pipelines. Intermediate results of each the processing steps of the channels can be compared to determine if faults have occurred at any point during the processing. Additionally, the final outputs of the channels can be compared to determine if a fault has occurred.

Digital chip 325 includes controller 335, which monitors down times of the FMCW LIDAR system 100. During the down times, controller 335 sends control signal 322 to analog signal generator 310. Analog signal generator 310 injects a predetermined analog signal into trans-impedance amplifiers (TIAs) 305 and TIA 315. For example, the analog signal generator 310 may generate a sinusoid with one frequency or multiple frequencies (e.g., mixture of multiple sinusoids). TIA 305 produces analog signal 320, and TIA 315 produces analog signal 324. ADC 330 converts analog signal 320 to a digital signal (digital data stream) and sends the digital data stream as an input data stream to beam digital signal processor 345. Likewise, ADC 340 converts analog signal 324 into a digital data stream and sends the digital data stream as an input data stream to beam digital signal processor 350.

Beam digital signal processor 345 generates an output data stream that is sent to packetizer 370. The output data stream also feeds into checksum generator 355. In some embodiments, checksum generator 355 is continuously computing a checksum based on the output data stream from beam digital signal processor 345. When the output data stream finishes, checksum generator 355 has a final checksum based on the entire output data stream. Similarly, beam digital signal processor 350 generates an output data stream that is sent to packetizer 375. The output data stream also feeds into checksum generator 360, which generates a checksum similar to that discussed above.

Comparator 365 compares the results from checksum generator 355 and checksum generator 360 and produces a fault signal 366 when the two checksums are nonequivalent. In some embodiments, comparator 365 determines whether to invoke a fault based on whether the two results match exactly. In another embodiment comparator 365 determines whether to generate a fault based on whether the two results are within a range threshold range (e.g., +/−2%). Fault signal 366 indicates that a failure is present somewhere within TIA 305 or 315, ADC 330 or 340, or beam digital signal processor 345 or 350.

To test packetizer 370 and 375 circuitry, the digital output stream from packetizer 370 feeds into checksum generator 380, and the digital output stream from packetizer 375 feeds into checksum generator 385. When the output data stream finishes, checksum generator 380 has a final checksum based on the entire output data stream from packetizer 370, and checksum generator 385 has a final checksum based on the entire output data stream from packetizer 375.

Comparator 390 compares the results from checksum generator 380 and checksum generator 385, and produces a fault signal 392 when the two checksums are nonequivalent. In some embodiments, comparator 390 determines whether to generate the fault signal 392 based on whether the two results match exactly. In another embodiment, comparator 390 determines whether to generate the fault signal 392 based on whether the two results are within a range threshold range (e.g., +/−2%). When comparator 365 does not generate fault signal 366, but comparator 390 generates fault signal 392, then a failure is within packetizer 370 or 375.

FIG. 4 is a block diagram illustrating an example of testing digital circuity by injecting a known digital signal into multiple channels and comparing results generated by the multiple channels, according to some embodiments of the present disclosure. In some embodiments, the FMCW LIDAR system 100 may begin by performing tests as shown in FIG. 3. Then, the FMCW LIDAR system 100 may further test the digital circuitry as shown in FIG. 4 using digital signal generator 410. Although using a known analog signal as shown in FIG. 3 provides overall test coverage for analog chip 302, digital chip 325, and the connections between the chips, using digital signal generator 410 as shown in FIG. 4 provides increased test coverage of the digital circuitry in digital chip 325 because the digital signal generator 410 can generate a wider variety of predetermined signals.

In some embodiments, the digital signal generator 410 may be a replay RAM where a predetermined signal can be stored and replayed during downtime of the FMCW LIDAR system 100. In some embodiments, the digital signal generator 410 may programmable via software. For example, the digital signal generator 410 may be programmed to generate a particular digital signal and be programmed to generate any type or sequence of digital signals.

Controller 335 instructs digital signal generator 410 to generate a known digital signal into beam digital signal processor 345 and beam digital signal processor 350 during down times. Similar to what was discussed above, beam digital signal processor 345 generates an output data stream that feeds into packetizer 370 and checksum generator 355.

In some embodiments, checksum generator 355 is continuously computing a checksum based on the output data stream from beam digital signal processor 345. When the output data stream finishes, checksum generator 355 has a final checksum based on the entire output data stream. Similarly, beam digital signal processor 350 generates an output data stream that is sent to packetizer 375. The output data stream also feeds into checksum generator 360, which computes a checksum similar to that discussed above.

Comparator 365 compares the results from checksum generator 355 and checksum generator 360 and produces a fault signal 366 when the two checksums are nonequivalent. In some embodiments, comparator 365 determines whether to generate a fault signal based on whether the two results match exactly. In another embodiment comparator 365 determines whether to generate a fault signal based on whether the two results are within a range threshold range (e.g., +/−2%). Fault 366 indicates that a failure is present somewhere within beam digital signal processor 345 or 350.

To test packetizer 370 and 375 circuitry, the digital output stream from packetizer 370 feeds into checksum generator 380, and the digital output stream from packetizer 375 feeds into checksum generator 385. When the output data stream finishes, checksum generator 380 has a final checksum based on the entire output data stream from packetizer 370, and checksum generator 385 has a final checksum based on the entire output data stream from packetizer 375.

Comparator 390 compares the results from checksum generator 380 and checksum generator 385 and produces a fault signal 392 when the two checksums are nonequivalent. In some embodiments, comparator 390 determines whether to generate a fault signal based on whether the two results match exactly. In another embodiment comparator 390 determines whether to generate a fault signal based on whether the two results are within a range threshold range (e.g., +/−2%). When comparator 365 does not generate fault signal 366, but comparator 390 generates fault signal 392, then a failure is within packetizer 370 or 375.

FIG. 5 is a block diagram illustrating an example of testing digital circuity by injecting a known digital signal into a single digital circuit and comparing results generated by the signal digital channel with a known stored value, according to some embodiments of the present disclosure. In some embodiments, the FMCW LIDAR system 100 may begin by performing tests as shown in FIG. 3. Then, the FMCW LIDAR system 100 may further test the digital circuitry as shown in FIG. 4. To further determine which one of the digital circuits are causing a fault, the FMCW LIDAR system 100 may individually test the digital circuits as shown in FIG. 5.

System 500 includes controller 335, which instructs digital signal generator 410 to generate a known digital signal (input data stream) during down times. Beam digital signal processor 345 processes the known digital signal via digital logic 505 and software processing 510. Digital logic 505 is hardware circuitry that is under test, and software processing 510 is software that overseas digital logic 505. Beam digital signal processor 345 generates an output data stream that feeds into packetizer 370 and checksum generator 355.

In some embodiments, checksum generator 355 is continuously computing a checksum based on the output data stream from beam digital signal processor 345. When the output data stream finishes, checksum generator 355 has a final checksum based on the entire output data stream.

Programmable value 520 is a known value that is stored in digital chip. For example, digital chip 325 may store various known values in programmable value 520 based on the type of digital signal that is generated by digital signal generator 410. Comparator 365 compares the results from checksum generator 355 with programmable value 520 and produces a fault signal 366 when the two values are nonequivalent. In some embodiments, comparator 365 determines whether to generate a fault signal based on whether the two results match exactly. In another embodiment comparator 365 determines whether to generate a fault signal based on whether the two results are within a range threshold range (e.g., +/−2%). Fault signal 366 indicates that a failure is present somewhere within beam digital signal processor 345.

To test packetizer 370, the digital output stream from packetizer 370 feeds into checksum generator 380, and comparator 390 compares the results from checksum generator 380 with a known value stored in digital chip 325. Comparator 390 produces a fault signal 392 when the two values are nonequivalent. Fault signal 392 indicates that a failure is present somewhere within packetizer 370 when fault signal 366 is not present.

In some embodiments, the FMCW LIDAR system 100 tests each digital channel according to the embodiment shown in FIG. 5. For example, after testing channel 0, the FMCW LIDAR system 100 proceeds to test channel 1, then channel 2, etc.

FIG. 6 is a block diagram illustrating an example of testing analog circuity and inter-chip connections by injecting a known analog signal into a single channel and comparing results generated by the channel with a known stored value, according to some embodiments of the present disclosure. In some embodiments, when the FMCW LIDAR system 100 performs tests as shown in FIGS. 3 and 4 and determines that a failure is present in the analog portion or ADC in a channel, the FMCW LIDAR system 100 may narrow down the channel causing the failure by performing single channel tests shown in FIG. 6.

System 600 tests analog chip 302, the connection between analog chip 302 and digital chip 325, and ADC 330. Controller 335 sends control signal 322 to analog signal generator 310. Analog signal generator 310 is configured to inject a known analog signal into TIA 305 which produces an analog signal 320 that feeds into ADC 330. ADC 330 converts analog signal 320 to a digital signal and feeds the digital signal into ADC signal metrics computation 605. In some embodiments, ADC signal metrics computations 605 compare the received digital signal with programmable value 615 to determine whether the received digital signal is within expected bounds and thus determine whether the received digital signal includes one or more faults. The metrics may include peak intensity of an initial fast Fourier transform (FTT) and a final FFT to determine if it is within bounds, a phase slope for a tone provided through the ADC, etc. In some embodiments, system 600 checks for frequency peaks and expected output results. In some embodiments, analog signal generator 310 is configured to inject the know analog signal into TIA 305 for one or more sweeps for every frame processed by the FMCW LIDAR system 100.

FIG. 7 is a block diagram illustrating an example of detecting faults in an optical source controller of a LIDAR system, according to some embodiments of the present disclosure. System 700 includes optical source controller 720 and amplifier DAC 725. In some embodiments, optical source controller 720 is located in LIDAR control systems 110 and amplifier DAC 725 is located in signal conversion unit 106 shown in FIG. 1.

During periods of down time, optical source fault detection 710 sends optical source configuration parameters 715 to optical source controller 720. The optical source configuration parameters 715 may include frequency modulation, power levels, etc. Optical source controller 720 uses amplifier DAC 725 to control a laser diode, which transmits an optical beam out to an environment. The optical beam reflects off of the environment as discussed above to produce a returned beam signal 735.

Returned beam signal 735 feeds into TIA 305 and into ADC 330. The digital output of ADC 330 feeds into optical source fault detection 710. Optical source fault detection 710 compares properties of returned beam signal 735 with optical source configuration parameters 715 to determine whether they are equivalent. In some embodiments, optical source fault detection 710 monitors instantaneous frequency measurements and a noise level scan of the FMCW LIDAR system 100. Optical source fault detection 710 compares the frequency modulation of returned beam signal 735 with the expected frequency modulation from optical source configuration parameters 715. If the difference is larger than a threshold, then optical source fault detection 710 generates fault signal 740.

In some embodiments, optical source fault detection 710 compares the noise level of returned beam signal 735 to expected noise levels (which directly correspond proportionately to laser power levels). If the difference between the noise level and expected noise level differs by more than a threshold, then optical source fault detection 710 generates fault signal 740.

FIG. 8 is a block diagram illustrating an example of detecting faults in optical scanner optics of an FMCW LIDAR system, according to some embodiments of the present disclosure. System 800 shows digital chip 325 testing optical scanner 102 using optical scanner fault detection 810. Optical scanner fault detection 810 sends scanner configuration parameters 820 to optical scanner 102, such as azimuth and elevation position information. Optical scanner fault detection 810 receives scanner feedback information 840, which includes optical scanner 102's actual azimuth and elevation position information. Optical scanner fault detection 810 compares the expected positions with the actual position and generates fault 850 when the two differ by a threshold. In some embodiments, the expected positions may be determined by a known scan pattern of the optical scanner. If the points of the measured scan pattern differ from the expected scan pattern by a threshold amount then a fault signal can be generated.

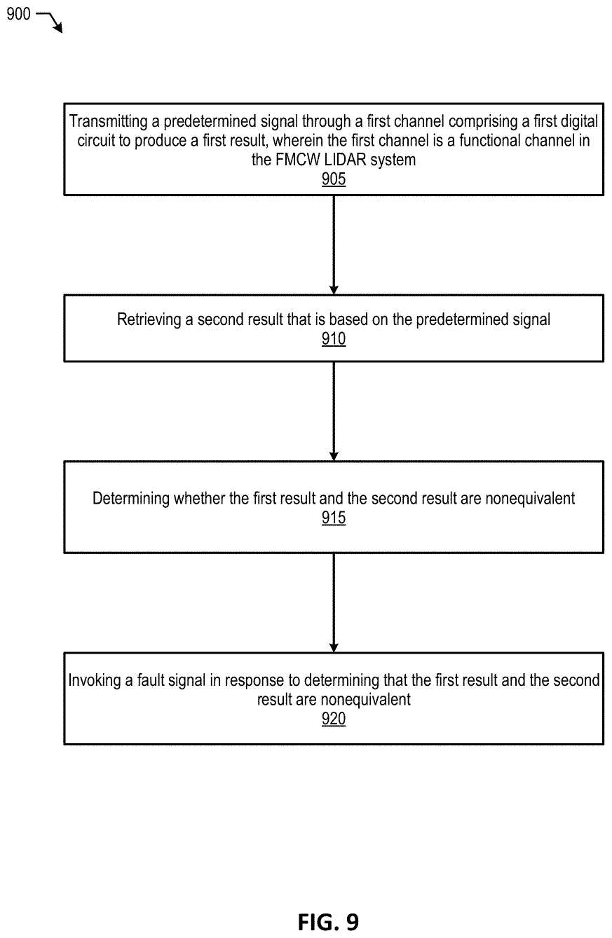

FIG. 9 is a flow diagram illustrating a method for detecting faults in a LIDAR system, according to some embodiments of the present disclosure. The method 900 may be performed by any suitable LIDAR system and various components, including the LIDAR system 100 described above. Additional, fewer, or different operations may be performed in the method depending on the particular arrangement. In some embodiments, some or all operations of method 900 may be performed by one or more processors executing on one or more computing devices, systems, or servers (e.g., remote/networked servers or local servers).

In some embodiments, method 900 may be performed by a signal processing unit, such as signal processing unit 112 in FIG. 1. Each operation may be re-ordered, added, removed, or repeated. In some embodiments, method 900 may be performed by processing logic including hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

In some embodiments, the method 900 may include operation 905 of transmitting a predetermined signal through a first channel that includes a first digital circuit to produce a first result. The first channel is a functional channel in the FMCW LIDAR system. In some embodiments, the method 900 may include operation 910 of retrieving a second result that is based on the predetermined signal. In some embodiments, the method 900 may include operation 915 of determining, by a processor, whether the first result and the second result are nonequivalent. In some embodiments, the method 900 may include operation 920 of invoking a fault signal in response to determining that the first result and the second result are nonequivalent.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operation may be performed, at least in part, concurrently with other operations. Instructions or sub-operations of distinct operations may be performed in an intermittent or alternating manner.

The above description of illustrated implementations of the present disclosure, including what is described in the Abstract, is not intended to be exhaustive or to limit the present disclosure to the precise forms disclosed. While specific implementations of, and examples for, the present disclosure are described herein for illustrative purposes, various equivalent modifications are possible within the scope of the present disclosure, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A method of fault detection in a frequency modulated continuous wave (FMCW) light detection and ranging (LIDAR) system, the method comprising:
transmitting a predetermined signal through a first channel comprising a first digital circuit to produce a first result, wherein the first channel is a functional channel in the FMCW LIDAR system;
retrieving a second result that is based on the predetermined signal;
determining, by a processor, whether the first result and the second result are nonequivalent; and
invoking a fault signal in response to determining that the first result and the second result are nonequivalent.

2. The method of claim 1, wherein the predetermined signal is an input data stream, the method further comprising:
processing, by the first digital circuit, the input data stream to produce a first output data stream;
computing a first checksum from the first output data stream, wherein the first checksum is the first result;
transmitting the input data stream through a second channel comprising a second digital circuit to produce a second output data stream;
computing a second checksum from the second output data stream, wherein the second checksum is the second result; and
invoking the fault signal responsive to determining that the first checksum is nonequivalent to the second checksum.

3. The method of claim 1, wherein the FMCW LIDAR system comprises an analog chip and a digital chip, the analog chip comprising a first analog circuit and a second analog circuit, and the digital chip comprising the first digital circuit and a second digital circuit, the method further comprising:
configuring the first analog circuit and the second analog circuit to produce a first analog output and a second analog output, respectively;
converting, by a first ADC and a second ADC in the digital chip, the first analog output to a first digital signal and the second analog output to a second digital signal, respectively;
processing, by the first digital circuit, the first digital signal to produce the first result; and
processing, by the second digital circuit, the second digital signal to produce the second result.

4. The method of claim 1, wherein the predetermined signal is an input data stream, the method further comprising:
processing, by the first digital circuit, the input data stream to produce an output data stream;
feeding the output data stream into checksum circuitry to produce the first result, wherein the first result is a checksum; and
comparing the checksum with the second result, wherein the second result is a predetermined checksum value.

5. The method of claim 1, wherein the first channel comprises an analog chip coupled to a digital chip, the method further comprising:
transmitting the predetermined signal at the analog chip, wherein the analog chip produces an analog signal that feeds into the digital chip;
converting, by an ADC in the digital chip, the analog signal to a digital signal;
processing, by the first digital circuit included in the digital chip, the digital signal to produce the first result; and
wherein the second result is a predetermined value that is stored in the digital chip.

6. The method of claim 1 further comprising:
sending optical source configuration parameters to an optical source controller, wherein the optical source controller generates a control signal based on the optical source configuration parameters for transmitting an optical beam into an environment;
processing, by the first channel, a returned beam signal reflected from the environment corresponding to the optical beam, wherein the processing produces return beam properties of the returned beam signal;
comparing the return beam properties with the optical source configuration parameters; and
invoking the fault signal in response to determining that the return beam properties and the optical source configuration parameters are nonequivalent.

7. The method of claim 1 further comprising:
sending scanner configuration parameters to an optical scanner;
receiving scanner feedback information from the optical scanner based on the scanner configuration parameters;
comparing the scanner feedback information with the scanner configuration parameters; and
invoking the fault signal in response to determining that the scanner feedback information and the scanner configuration parameters are nonequivalent.

8. A frequency-modulated continuous wave (FMCW) light detection and ranging (LIDAR) system, the system comprising:
a first channel comprising a first digital circuit;
a signal generator to transmit a predetermined signal through the first channel to produce a first result;
a processor; and
a memory to store instructions that, when executed by the processor, cause the system to:
retrieve a second result that is based on the predetermined signal;
determine whether the first result and the second result are nonequivalent; and
invoke a fault signal when the first result and the second result are nonequivalent.

9. The system of claim 8, wherein the predetermined signal is an input data stream, the system further comprising:
a second channel comprising a second digital circuit;
the signal generator to transmit the input data stream through the first digital circuit and the second digital circuit to produce a first output data stream and a second output data stream, respectively;
first checksum circuitry to receive the first output data stream to produce a first checksum, wherein the first checksum is the first result; and
second checksum circuitry to receive the second output data stream to produce a second checksum, wherein the second checksum is the second result.

10. The system of claim 8, further comprising:
an analog chip comprising a first analog circuit and a second analog circuit;
a digital chip comprising the first digital circuit and a second digital circuit;
the signal generator to configure the first analog circuit and the second analog circuit to produce a first analog output and a second analog output, respectively;
a first analog to digital converter (ADC) and a second ADC to convert the first analog output to a first digital signal and the second analog output to a second digital signal, respectively;
the first digital circuit to process the first digital signal to produce the first result; and
the second digital circuit to process the second digital signal to produce the second result.

11. The system of claim 8, wherein the predetermined signal is an input data stream, the system further comprising:
the first digital circuit to process the input data stream to produce an output data stream;
checksum circuitry to receive the output data stream to produce the first result, wherein the first result is a checksum; and
wherein the second result is a predetermined checksum value stored in the memory.

12. The system of claim 8, further comprising:
an analog chip comprising analog circuitry;
a digital chip comprising the first digital circuit and functionally coupled to the analog chip;
the signal generator to transmit the predetermined signal at the analog chip through the analog circuitry to produce an analog signal;
an ADC that receives the analog signal to produce a digital signal;
the first digital circuit to receive the digital signal and produce the first result; and
wherein the second result is a predetermined value that is stored in the memory.

13. The system of claim 8 further comprising:
an optical source controller that receives optical source configuration parameters to produce a control signal based on the optical source configuration parameters to transmit an optical beam into an environment;
the first channel to process a returned beam signal reflected from the environment to identify return beam properties of the returned beam signal; and
wherein the instructions, when executed by the processor, cause the system to:
compare the return beam properties with the optical source configuration parameters; and
invoke the fault signal when the return beam properties and the optical source configuration parameters are nonequivalent.

14. The system of claim 8, further comprising:
an optical scanner that receives a set of scanner configuration parameters to produce scanner feedback information; and
wherein the instructions, when executed by the processor, cause the system to:
compare the scanner configuration parameters with the scanner feedback information; and
invoke the fault signal when the scanner configuration parameters and the scanner feedback information are nonequivalent.

15. A frequency-modulated continuous wave (FMCW) light detection and ranging (LIDAR) system, the system comprising:
a first channel comprising a first digital circuit;
a signal generator to transmit a predetermined signal through the first channel to produce a first result;
a processing circuitry; and
a memory to store instructions that, when executed by the processing circuitry, cause the system to:
retrieve a second result that is based on the predetermined signal;
determine whether the first result and the second result are nonequivalent; and
invoke a fault signal when the first result and the second result are nonequivalent.

16. The system of claim 15, wherein the predetermined signal is an input data stream, the system further comprising:
a second channel comprising a second digital circuit;
the signal generator to transmit the input data stream through the first digital circuit and the second digital circuit to produce a first output data stream and a second output data stream, respectively;
first checksum circuitry to receive the first output data stream to produce a first checksum, wherein the first checksum is the first result; and
second checksum circuitry to receive the second output data stream to produce a second checksum, wherein the second checksum is the second result.

17. The system of claim 15, further comprising:
an analog chip comprising a first analog circuit and a second analog circuit;
a digital chip comprising the first digital circuit and a second digital circuit;
the signal generator to configure the first analog circuit and the second analog circuit to produce a first analog output and a second analog output, respectively;
a first analog to digital converter (ADC) and a second ADC to convert the first analog output to a first digital signal and the second analog output to a second digital signal, respectively;
the first digital circuit to process the first digital signal to produce the first result; and
the second digital circuit to process the second digital signal to produce the second result.

18. The system of claim 15, wherein the predetermined signal is an input data stream, the system further comprising:
the first digital circuit to process the input data stream to produce an output data stream;
checksum circuitry to receive the output data stream to produce the first result, wherein the first result is a checksum; and
wherein the second result is a predetermined checksum value stored in the memory.

19. The system of claim 15, further comprising:
an analog chip comprising analog circuitry;
a digital chip comprising the first digital circuit and functionally coupled to the analog chip;
the signal generator to transmit the predetermined signal at the analog chip through the analog circuitry to produce an analog signal;
an ADC that receives the analog signal to produce a digital signal;
the first digital circuit to receive the digital signal and produce the first result; and
wherein the second result is a predetermined value that is stored in the memory.

20. The system of claim 15 further comprising:
an optical source controller that receives optical source configuration parameters to produce a control signal based on the optical source configuration parameters to transmit an optical beam into an environment;
the first channel to process a returned beam signal reflected from the environment to identify return beam properties of the returned beam signal; and
wherein the instructions, when executed by the processing circuitry, cause the system to:
compare the return beam properties with the optical source configuration parameters; and
invoke the fault signal when the return beam properties and the optical source configuration parameters are nonequivalent.
